(19) United States
(12) Patent Application Publication
(10) Pub. No.: US 2012/0310203 A1
(43) Pub. Date: Dec. 6, 2012

(54) APPARATUS AND METHOD

(75) Inventors: Maher Khaled, Cambridge (GB); Daniel Wren Wheeler, Cambridge (GB); Steven John Suchting, Cambridge (GB); Daniel Peterson Godfrey, Cambridge (GB); Samuel Gilbert Willis, Cambridge (GB); Luke William Stephens, Cambridge (GB)

(73) Assignee: CAMBRIDGE ENTERPRISE LIMITED, Cambridge (UK)

(21) Appl. No.: 13/522,786

(22) PCT Filed: Jan. 18, 2011
(86) PCT No.: PCT/GB11/50069

§ 371 Date: Aug. 16, 2012

(30) Foreign Application Priority Data
Jan. 19, 2010 (GB) 1000806.8
Mar. 4, 2010 (GB) 1003595.4

(51) Int. Cl. A61J 1/14; A61J 1/20

(52) U.S. Cl. 604/404; 604/403; 604/406

(57) ABSTRACT

This invention relates to medical devices for labelling a syringe filled from an ampoule, and to safer devices for filling a syringe from an ampoule, and to associated methods. We describe a device for attaching to an ampoule to label a syringe filled from the ampoule, the device comprising: an ampoule-mounting portion for mounting the device to a filled ampoule; a syringe-fitting portion to enable the device to be fitted onto said syringe; and a label holder to hold a label for contents of said ampoule; and wherein one of said syringe and said ampoule is detachable from said device; and wherein said label is configured such that in conjunction with a filling operation of said syringe and detachment of said one of said syringe and said ampoule from said device said syringe is labelled by said label.

### FIELD OF THE INVENTION

This invention relates to medical devices for labelling a syringe filled from an ampoule, to safer devices for filling a syringe from an ampoule, and to associated methods.

### BACKGROUND TO THE INVENTION

An estimated 180,000 patients die in the US each year as a result of adverse medical events and medication error is a leading contributing factor. In an analysis of medication errors reported to the United States Pharmacopoeia (USP) voluntary Medication Errors Reporting Program for a one-year period between 1996 and 1997, the USP found that 33% of the reports cited labelling or packaging as having contributed to the medication error (USP 1998). In nearly 30% of the fatalities reported, labelling or packaging was cited as a contributing factor to the medication error that led to the fatality (USP 1998). A survey of 687 Canadian anaesthesiologists identified 1038 drug-related events; the misidentification of a syringe or “syringe swap” was the most common cause of error.

It can be easy to mistake one drug for another, even though careful thought is given to packaging design. There is a particular problem with intravenous drugs, as they are often supplied in small ampoules and their labels can be difficult to read and must be transferred into another correctly-labelled device (typically a syringe) before they are administered. Misidentification of drug syringes or ampoules is an important cause of medication errors during anaesthesia. An Australian Incident Monitoring Study reported that 144 out of 2000 anaesthetic incidents involved situations in which the wrong drug was given or almost given. The risk of actual administration of a wrongly selected drug was higher if the drug was in a syringe (93%) rather than an ampoule (58%).

Colour coding syringe labels can help to decrease the incidents of drug errors but mislabelling remains a significant problem. Other problems associated with the use of ampoules include cut fingers, lack of sterility, and glass powder in the injected drug, which can be deposited in patients' lungs if they enter the circulation.

One of the inventors has carried out research into these problems and background information can be found in: “Variability in the concentrations of intravenous drug infusions prepared in a critical care unit”, Daniel Wheeler et al., Intensive Care Med, DOI 10.1007/s00134-008-1113-9, Springer-Verlag 2008; and in the review article “Medication errors in anaesthesia and critical care”, S. J. Wheeler and D. W. Wheeler, Anaesthesia, 2005, 60, pages 257-273. The inventor's research into drug administration errors and problems with patient safety has informed the aspects and embodiments of the invention described later.

One previous approach to addressing these problems is to couple a bar code reader to an anaesthetic machine, but this device reads the sticker rather than the labelled contents and it still relies upon the sticker being applied to the syringe correctly. A simple device to help break the top off an ampoule is also known from U.S. Pat. No. 6,099,510, but this is of little help in addressing the above problems.

### SUMMARY OF THE INVENTION

According to a first aspect of the invention there is therefore provided a device for attaching to an ampoule to label a syringe filled from the ampoule, the device comprising: an ampoule-mounting portion for mounting the device to said ampoule; a syringe-fitting portion to enable the device to be fitted onto said syringe; and a label holder to hold a label for contents of said ampoule; wherein one of said syringe and said ampoule is detachable from said device; and wherein said label is configured such that in conjunction with a filling operation of said syringe and detachment of said one of said syringe and said ampoule from said device said syringe is able to be labelled by said label.

In use embodiments of the device may be shipped permanently fitted to a filled ampoule, with the (empty) syringe being fitted immediately prior to use.

In some embodiments the label is detachable from the device for attachment to the syringe in conjunction with (before, during or after) the filling operation; the label holder may then simply be a part of the device to which the label is initially attached. Preferably in such an approach the detachable label is positioned such that the label must be at least partially removed for an effective filling operation.

Thus, for example, in one approach (our code name Marshall) the device is one-piece moulded and configured to fit over and preferable snap onto a snap-top (neck) of the ampoule. The label is attached across the syringe fitting so that the syringe cannot be inserted into its female mating portion (luer) without removing a label. In use the fitted syringe provides a lever which may be employed to snap off the top of the ampoule. Thus in this approach the label is detachable and must be removed in order to be able to insert the syringe; the user is thus encouraged to place the removed label directly onto the syringe. Leverage from the syringe is then used to snap the top off the ampoule, and then the syringe, with the device attached, is placed over the open top of the ampoule to aspirate the contents.

In another approach (our code name Hartke) again the label is detachable and must be removed in order to operate the device. However in this instance the label is applied across a side of the snap-top of the ampoule so that the ampoule top cannot be snapped off without removing the label. In an example of this approach the ampoule mounting portion (ampoule holder) holds the ampoule in a cradle along its length. A hinged portion is located above the ampoule in the cradle so that it can be hinged down to bear onto the snap-top, past the label, which must therefore be removed to operate the device. In preferred embodiments the hinged portion comprises the syringe fitting portion, again to provide leverage, and may comprise a projection at the end of an arm. In embodiments the projection may comprise a female mating portion (luer) for the syringe. Thus the device may be configured such that once the snap-top has been broken off rotation (of the luer component) about the hinge may be continued so that the projection moves into the now open top of the ampoule for aspiration of the contents. A cavity may be provided in the cradle substantially opposite the hinge to receive the snapped off top, which is then retained within the cavity by the syringe. Thus, in use, the ampoule and syringe may begin by being arranged alongside one another with the syringe inserted into the luer of the hinged mating portion, and the hinged mating portion may then be rotated so that the syringe moves through 180° to align with the then opened ampoule.

In a still further embodiment (our code name Fender) the ampoule-mounting portion contains the ampoule sufficiently for a space above the top of the ampoule to be substantially airtight except for an air bleed hole. An optional (air-tight) opening may be provided to enable the label of the ampoule to be read, depending whether the container is transparent. The label is provided over the air bleed hole so that this label needs to be removed in order for the contents of the ampoule to be aspirated. To enable the top to be snapped off a push-button arrangement may be provided in the closed-top ampoule-mounting portion, in order to allow a user to apply pressure to the snap-top of the ampoule. The syringe fitting portion provides a substantially airtight fit to the syringe. Then, in use, the label must be removed from the air bleed hole (and attached to the syringe) to provide a route for air to enter the ampoule after the top has been snapped off when the contents are being aspirated (there being substantially no other air path into the ampoule).

In these and other arrangements the device has a portion configured for snapping off a snap-top of the ampoule. In the above described Fender device this comprises a push button region of the ampoule housing; in the Hartke device this comprises a hinged portion of the device, in particular the hinged syringe-fitting portion; in the Marshall-type device this comprises a (snap) cap for the snap-top of the ampoule.

In a still further approach (our code name Ampeg) this comprises a collar, in particular sized to fit the snap-top of an ampoule (ampoules are of standard, albeit different, sizes). In embodiments of this latter arrangement, the syringe fitting portion clips to the syringe and the ampoule-mounting portion clips to the ampoule in embodiments by a collar around the neck of the snap-top. In embodiments the collar is hingedly attached to the syringe-fitting portion (and may be folded back onto the syringe fitting portion after use). This enables the syringe-fitting portion to be articulated with respect to the ampoule-mounting portion (collar) to snap the top off the ampoule, which may then be removed from the device and filled in the normal way. In this approach the device remains attached to the syringe, along with the label it bears. In such an approach preferably the device is shipped together with the syringe and ampoule so that the label, which is attached to the device, remains on the syringe after aspiration of the drug from the ampoule.

Thus, broadly speaking, in some preferred embodiments the syringe-fitting portion is mounted to allow motion of the syringe-fitting portion relative to the device, more particularly relative to the ampoule-mounting portion. This motion applies a force to snap off the snap-top of the ampoule. In this way the syringe, when attached, may be used as a lever to snap off the snap-top of the ampoule. In some preferred embodiments a hinging motion or rotation about an axis is employed. The skilled person will, however, appreciate that other forms of motion may alternatively be employed—for example a rotation about a longitudinal axis (a screw-type motion) may be employed to apply force to the snap-top to open the ampoule.

In embodiments the label holder comprises a detachable item which is not released from the device until the snap-top of the ampoule has been removed, for example by configuring the device such that the label holder is released by snapping off the snap-top. This reduces the risk of the syringe being inadvertently labelled without aspirating the contents of the ampoule and then later the same syringe being used to aspirate the contents of a different ampoule.

The label holder comprises a part of the device bearing a label. It may, for example, have an adhesive label attached to it or a label (label information) may be moulded into this component/part of the device.

Although the above described embodiments have various different advantages including, for example, low cost, in some particularly preferred embodiments the device is configured for automatically labelling the syringe. Thus in such an arrangement the label holder is detachable from the device and configured such that, when the syringe is engaged with the syringe-fitting portion of the device and then removed from the syringe-fitting portion, the label holder attaches to the syringe and is detached from the device to thereby automatically label the syringe. The skilled person will appreciate that there are many ways in which the label holder could be configured in such a manner including, for example, connection to the syringe by adhesive, by a ratchet, by a one-way lock mechanism, by a compression fitting and/or by the use of teeth or barbs, which may be arranged to provide a one-way slide fit of the label holder to the syringe. One preferred approach, which is inexpensive, is to employ a label holder with a collar which fits around and grips the syringe, in particular a split collar of slightly smaller internal diameter than the syringe. This can provide a push/friction fit over the syringe, gripping the syringe when the syringe is removed. In embodiments, however, a combination of the above described approaches may be employed. For example, in a moulded version of the device barbs may be preferable.

Where the label holder comprises a collar for the syringe, this may be of clear plastic, so that gradations on the syringe are visible through the collar, and so that air bubbles can be more easily expelled. This is particularly advantageous with smaller syringes, for example, less than 5 ml, where for small doses a 1-2 ml volume would be behind the collar. Alternatively the collar may be arranged so that it can be pulled all the way to the distal end of the syringe (syringes have a flange at the distal end which would inhibit removal of the collar).

In embodiments the collar and/or device is tinted or coloured, for example by using coloured plastic, to match a colour of the label on the ampoule (there is an international colouring standard for drugs of different types).

Thus in embodiments the label holder comprises a collar, in particular designed to grip onto the outside diameter of the syringe. Then, in use, as the syringe is pushed into the device the collar clasps the syringe and may, at the same time, let go of the device to facilitate detachment. In other embodiments, for example to facilitate manufacture, the label holder may be attached to the device (more particularly the ampoule-mounting portion) by thin, breakable plastic strands, similar to a tamper-evident ring on a bottle top. In such a case optionally a plurality of plastic or metal barbs may be provided, for example disposed circumferentially around the collar, to fasten the label holder onto the syringe. Then in embodiments it may only be possible to remove the label ring from the syringe destructively.

The label may comprise a conventional paper, plastic or cloth label and/or a barcode and/or an RFID (radio frequency identification) tag. Depending upon the diameter of the syringe there may be limited space for a label. In this case it can be advantageous if the label holder has a label-carrying portion, which is able to fold out longitudinally (i.e. parallel to the axis of the collar). In embodiments this portion is attached circumferentially to the collar. Initially it is folded down to lie alongside the ampoule, but after the label holder has attached to the syringe this can be hinged through approximately 180° to lie along the length of the syringe. This longitudinal piece may be attached to the curved circumference of the collar by a so-called living hinge, a butterfly hinge or bow-tie hinge which employs an over-centre stretch so that it has a bistable bias either up or down along the axis of the collar (in a similar manner to a plastic bottle flip-top). Use of a label of this type also has the advantage that the collar can be of low height so that it obscures little of the longitudinal length (gradations) of the syringe.

Preferred embodiments of the device also provide a cavity to hold the snap-top after this has been snapped off, to retain the broken glass within the device for safety. Depending upon the regulatory environment this may allow the device to be disposed of as conventional waste rather than as special “sharps” waste, which is expensive. Thus in embodiments, after use the snap-top is substantially entirely within the cavity. Embodiments of the device may therefore also include one or more interlocks, for example plastic snap-lock features, to constrain the device to one-time use.

We now describe another aspect of the invention which facilitates sharp-free filling of a syringe from an ampoule. The skilled person will appreciate that features of the various aspects and embodiments of the invention that we describe may be, and in embodiments are, combined.

Thus in another aspect the invention provides a device for attaching to an ampoule to facilitate filling a syringe from the ampoule, the device comprising: an ampoule-mounting portion for mounting the device to a filled ampoule; and a syringe-fitting portion to enable the device to be fitted onto said syringe; wherein the device has two configurations, a first, syringe-attaching configuration for attaching said syringe to the device and a second, syringe-filling configuration for filling said syringe with liquid from said filled ampoule; wherein the device is reconfigurable between said first configuration and said second configuration; and wherein said reconfiguration between said first configuration and said second configuration applies a force to snap-off a snap-top of said ampoule.

The reconfiguration of the device between the first, syringe-attaching configuration and the second syringe-filling configuration may be achieved in a number of different ways. For example it may be achieved by a relative twist between the two portions of the device, using a long-pitch thread, or it may be achieved using a sliding or translational motion between the portions of the device, or some combination of these. However in a particularly preferred embodiment the syringe-fitting portion of the device is hingedly attached to the ampoule mounting portion and these are initially at an (oblique) angle to one another (in the first configuration)—this can be seen, for example, in FIG. 1 described later. They are then brought into longitudinal alignment with one another to align the syringe to the ampoule for filling. This hinging or rotation action, in embodiments, brings a forcing portion of the device, for example a face or projection of the syringe filling portion of the device, to bear upon the snap-top of the ampoule, thereby snapping off the snap-top in moving from the syringe-attaching configuration to the syringe-filling configuration.

In some particularly preferred embodiments the connection or linkage between the syringe-fitting portion and the ampoule-mounting portion of the device allows both rotation and translation of one portion with respect to the other. More particularly in preferred embodiments the syringe filling portion is constrained to first predominantly rotate with respect to the ampoule-mounting portion, to snap the top off, and then to predominantly translate towards the ampoule mounting portion, so that a nozzle of the syringe fitting portion then moves into the open-top of the ampoule. (The ampoule and syringe combination is generally inverted when filling so that the ampoule is above the syringe, and the surface tension of the liquid, usually water-based, inhibits the liquid from flowing out around the nozzle).

There are different ways to achieve this rotation-translation motion depending, for example, on whether the device is intended for one-time use or multi-use. In the former case a relatively inexpensive plastic linkage is desirable; in the latter case a more robust linkage, which may incorporate metal parts, is desirable (and in the latter case the device should be sterilisable).

In the former case the hinged attachment may comprise a so-called four bar linkage, which can be arranged so that the connected portions first move generally to rotate with respect to one another, and then generally to translate with respect to one another. Such an arrangement may be one-piece plastic moulded, for example incorporating living hinges.

In a more robust embodiment the hinged attachment may comprise a sliding hinge, for example a rod able to translate along a slot. In this case the rotation-translation movement may be imposed by a camming surface between the syringe-fitting portion and the (ampoule-mounting portion of the) device, for example a camming surface provided on the main body moulding.

In embodiments the nozzle of the syringe-fitting portion may be moved such that it finishes 1-2 mm inside the ampoule. A rotation lock may be provided to inhibit rotation back once the syringe and ampoule are longitudinally aligned and/or one or more safety lock(s) may be provided to inhibit motion of the syringe-fitting portion away from the ampoule-mounting portion once the ampoule top has been snapped off (to safely trap the sharp top and/or to inhibit labelling the syringe without filling the syringe). This may be achieved by a simple plastic latch or ratchet.

In a single use device the device is preferably mounted to the ampoule during the ampoule production process, and labelled during the same process.

In embodiments the ampoule-fitting portion may be fabricated from a plastic material such as polyethylene, polycarbonate or polypropylene. However because these materials do not provide a good friction grip to an ampoule, preferably the ampoule-fitting portion is configured to hold an ampoule at both ends or, in embodiments, to enclose or encapsulate the ampoule. Within its holder the ampoule is oriented such that the scored edge of the snap-off top faces the part of the device which bears onto the top. In embodiments the ampoule holder and body of the device is formed as a single plastic component, for example as a clam shell-type component which is snapped together to hold/contain the ampoule inside.

The syringe-fitting portion comprises a female portion to mate with a proximal end of the syringe, typically by means of a nozzle with a slightly tapered bore, optionally threaded. In embodiments a standard luer fitting is employed. To accommodate the off-centre needles used in larger syringes the luer fitting may also be offset. The syringe fitting portion may comprise a second plastic component.

In a related aspect the invention provides a device for labelling a medical syringe, the device having an ampoule mounting portion for mounting the device to a filled ampoule, a detachable label holder to hold a label for the contents of said ampoule, and a syringe-fitting portion to enable the device to be fitted onto said syringe, and wherein said label holder is configured to engage said syringe on or after fitting of said syringe into said device such that on withdrawal of said syringe from said device after filling said detachable label-holder is detached from said device and attached to said syringe.

In a further related aspect the invention provides a device for enabling filling of syringe from an ampoule, the device comprising: an ampoule-mounting portion for mounting the device to a filled ampoule; a syringe-fitting portion to enable the device to be fitted onto said syringe; and a cavity for holding a snapped-off top of said ampoule; wherein said syringe fitting portion is hingedly attached to said ampoule mounting portion; wherein the device has two configurations, a first, syringe-attaching configuration in which an axis of the syringe fitting portion is at an oblique angle to an axis of said ampoule-mounting portion and a second syringe-filling configuration in which the syringe fitting portion and the ampoule-mounting portion are aligned to enable the syringe to be filled from the ampoule; wherein the device is reconfigurable between said first configuration and said second configuration and said configuration; and wherein, in going from said first to second configuration, the ampoule top is snapped off and the top is captured in the cavity.

Preferably the cavity is located substantially behind or underneath a hinging junction between said syringe-fitting portion and said ampoule-mounting portion.

In a further related aspect the invention provides a one-piece moulded device for attaching to an ampoule to facilitate filling a syringe from the ampoule, the device comprising: an ampoule-mounting portion for mounting the device to a filled ampoule; and a syringe-fitting portion to enable the device to be fitted onto said syringe; and wherein said ampoule-mounting portion comprises a cap for a snap-top of the ampoule; wherein said syringe-fitting portion comprises a female luer fitting for the syringe; wherein an opening of said cap to receive said ampoule faces in a generally opposite direction to an opening of said female luer fitting to receive said syringe such that, in use, said syringe and said ampoule are generally antiparallel; and wherein, in use, said syringe is usable as a lever to snap off said snap-top of said ampoule.

In embodiments a label is provided over the opening of the female luer fitting, as previously described.

In a further aspect the invention provides a method of automatically labelling a syringe, the method comprising: attaching a label to a device on an ampoule of liquid; fitting a syringe to the ampoule/device; filling the syringe with liquid from the ampoule; withdrawing the syringe from the ampoule with the label attached to the syringe.

In a still further aspect the invention provides a method of labelling a medical syringe, the method comprising: providing an ampoule; providing a device to couple said syringe to said ampoule, wherein said device is configured to enable loading of said syringe with contents of said ampoule without removal of said syringe from said device; engaging said syringe with said device such that a label holder attached to said device attached to said ampoule engages with said syringe; filling said syringe with said contents of said ampoule; and withdrawing said filled syringe from said device such that said label holder engaged with said syringe is carried by said syringe to label said syringe.

### Improved Aspiration

Tests of the above described arrangements have revealed that on occasion when the device is used to suck drug out from the inverted ampoule air comes into the ampoule to replace the withdrawn drug as largish bubbles. If the needle is not in the centre of the ampoule neck the air typically comes up the widest available passage and before the bubble breaks away from the edge of the ampoule to float to the top of the liquid (which is the base of the ampoule because the ampoule is upside down) it passes alongside the top of the filling needle. Thus as aspiration of the drug continues a portion of the air bubble that has just been drawn into the ampoule neck may be aspirated into the syringe. Depending upon the conditions up to 30% air may be aspirated.

Experiments have determined that two design features can ameliorate this problem: arranging the device so that the aspiration tip is off-centre in the neck opening when the contents of the ampoule are aspirated; and arranging for the suction at the aspiration tip to be asymmetrical, in embodiments by providing the aspiration tip with a nozzle having an opening on one side, and preferably closed at the tip end. Either of these features may be employed independently of the other, but preferably they are used in conjunction. Thus in embodiments the device holds the aspiration tip off-centre in such a way that the opening on the aspiration tip is on the side farthest from the most likely air ingress path; experiments with such an arrangement have demonstrated aspiration of substantially 100% liquid.

In one embodiment the aspiration tip has a longitudinal chamber or conduit closed at the end of the tip, and the nozzle is formed by providing an opening in a lateral side of the longitudinal chamber or conduit, in embodiments adjacent the end of the tip. The end of the aspiration tip may be slanted so that the side or face of the tip bearing the opening of the nozzle is longer than an opposite side or face of the tip without such an opening.

The above described arrangements are also useful outside the context of a syringe labelling device because typically a little air is aspirated when filling a syringe from an ampoule using a filling needle, albeit this is later tapped out.

Thus in a further aspect the invention provides a filling needle for filling a syringe from an ampoule, the filling needle comprising: a female luer for fitting the needle to the syringe; and an aspiration tip for aspirating the contents of the ampoule; and wherein said aspiration tip comprises a nozzle with an opening on one side.

Preferably, as previously described, the nozzle is closed at the end of the filling needle. The female luer may comprise, for example, a push fit or a luer lock connector.

The invention further provides a method of filling a syringe from an ampoule using such a filling needle, in which the ampoule is held in a generally inverted position and the filling needle is held off-centre with the side opening facing towards the closer side of the ampoule neck.

### BRIEF DESCRIPTION OF THE DRAWINGS

These and other aspects of the invention will now be further described, by way of example only, with reference to the accompanying figures in which:

FIGS. 1a to 1c show, respectively, an automatic syringe-labelling device according to an embodiment of the invention, and the device before and after insertion of a syringe for automatic labelling of the syringe;

FIGS. 2a to 2d show a sequence of steps illustrating use of the device of FIG. 1 for filling and labelling a syringe from an ampoule;

FIG. 3 shows a vertical cross-section view through the device of FIG. 1, and details of an example label holder of the device;

FIGS. 4a and 4b show, respectively, a perspective and cross-sectional view of the device in use to break the top off an ampoule;

FIGS. 5a to 5c show, respectively, a perspective view, an enlarged perspective view, and a vertical cross-section view through the device after breaking the top off an ampoule and prior to insertion of the nozzle of the female mounting portion of the syringe into the open top of the ampoule for aspiration of the contents;

FIGS. 6a and 6b show, respectively, a 3D perspective view and a cross-section view of the device after the nozzle of the female mating portion for the syringe has been inserted into the open top of the ampoule;

FIG. 7 illustrates aspiration of the contents and subsequent removal of the syringe bearing the label holder;

FIG. 8 shows a device (Marshall) for snapping off the top of an ampoule and labelling a syringe;

FIG. 9 shows the device of FIG. 8 in use;

FIG. 10 shows another device (Hartke) for snapping off the top of an ampoule and labelling a syringe;

FIG. 11 shows the device of FIG. 10 in use;

FIG. 12 shows a further example of a device (Fender) for snapping off the top of an ampoule and labelling a syringe, illustrating use of the device;

FIG. 13 shows a still further example of a device (Ampeg) for snapping off the top of an ampoule and labelling a syringe;

FIG. 14 shows the device of FIG. 13 in use;

FIGS. 15a to 15c show a preferred example of an aspiration tip for use in embodiments of the invention illustrating, respectively, a nozzle with an opening on one side, the nozzle inserted into the neck of an ampoule, and a vertical cross-sectional view showing a longitudinal chamber within the aspiration tip terminating with a closed end and a nozzle with a side opening; and

FIG. 16 shows a syringe labelling device having an integral syringe cap.

### DETAILED DESCRIPTION OF PREFERRED EMBODIMENTS

Broadly, according to one aspect of the invention we will describe a device for attaching to an ampoule to place a label referring to the contents of the ampoule to a syringe to be filled with the contents.

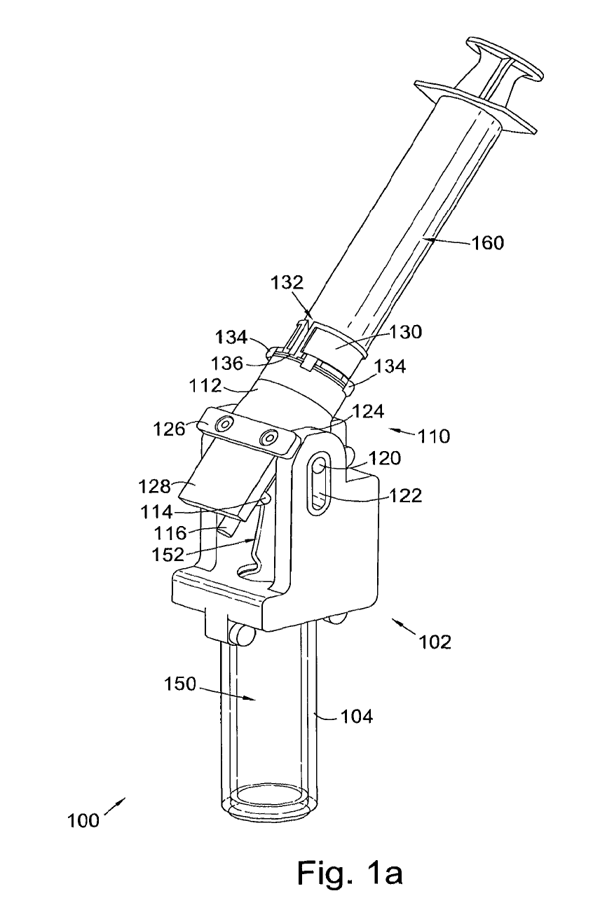

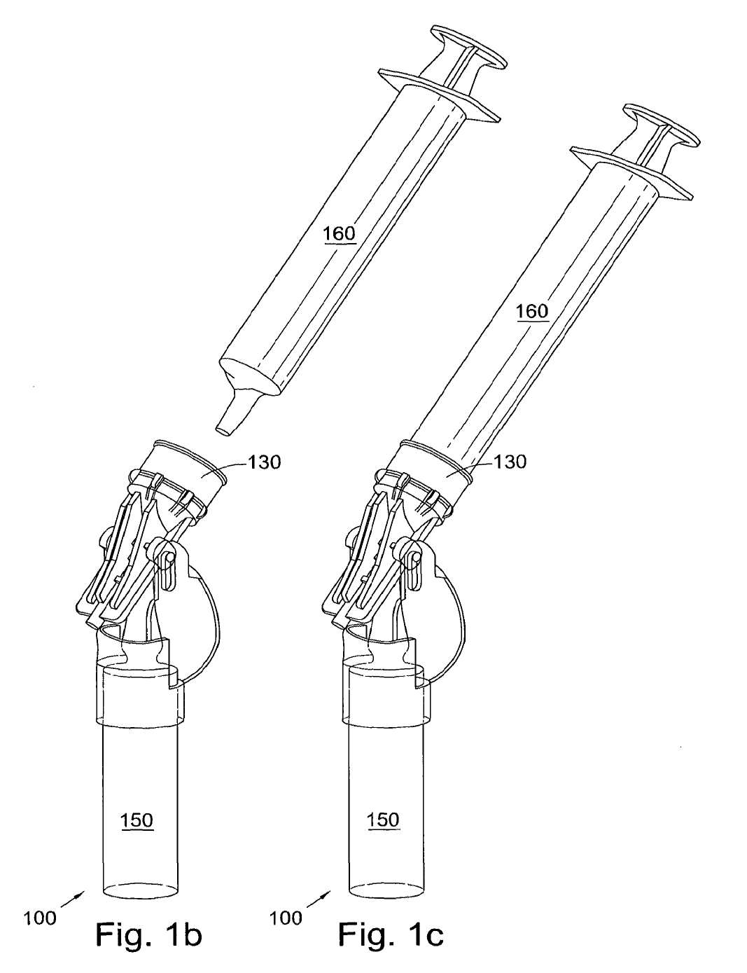

Referring to FIG. 1a this shows an embodiment 100 of a device for breaking the snap-top 152 of an ampoule 150 and for automatically labelling a syringe 160 after it is filled from the ampoule. The device comprises an ampoule mounting portion 102 including an ampoule holder 104 which, in the illustrated embodiment, contains the ampoule, optionally in clear plastic or with an opening to facilitate reading a label of the ampoule. The device also has a syringe-fitting portion 110 comprising a syringe housing 112 including a female luer fitting 114 having an aspiration tip or nozzle 116 for aspirating the contents of the ampoule. As illustrated the ampoule-mounting portion 102 of the device comprises a main body of the device and this is formed of two parts (front and rear) which attach or clamp around the ampoule 150 (in embodiments these may comprise a clamshell-type plastic moulding).

As illustrated, initially the syringe is at an oblique angle to the ampoule, and hence a longitudinal axis of the syringe fitting portion is at an oblique angle to a longitudinal axis of the ampoule-mounting portion. (The angle may be considered obtuse or acute, depending upon from where it is measured, although potentially in embodiments the syringe could either start straight or at 180° to the ampoule axis). The mechanism of the device is configured to constrain the syringe fitting portion (syringe) to first predominantly rotate with respect to the ampoule-mounting portion (ampoule) and then predominantly to translate towards the ampoule.

The illustrated embodiment is particularly suitable for multiple use, having a relatively robust mechanism. In the illustrated example this mechanism comprises a pivot 120 in a slot 122, optionally reinforced, to allow the syringe-fitting portion both to rotate and to translate with respect to the ampoule-mounting portion of the device. A surface 124 of the ampoule-mounting portion provides a cam surface and a portional plate 126 of the syringe fitting portion that acts as a cam follower moving over this surface. The cam surface has a curved portion at one end (a distal end with respect to the ampoule) followed by a substantially straight or flat portion so that the syringe-fitting portion must be rotated before it can be translated towards the ampoule.

The rotational motion brings a forcing portion or projection of the syringe-fitting part of the device to bear on the snap-top or cap 152 of the ampoule, to break this off and then the translational motion inserts the aspiration tip or nozzle 116 of the syringe-fitting part of the device into the then open ampoule top. The ampoule top is contained within a cavity (not shown) of the main body 102 of the device and, in embodiments, the syringe-fitting portion 110 is provided with a cover plate 128 for increased safety, to further inhibit broken glass from escaping from the device, and to inhibit user access to the sharp top of the opened ampoule.

The syringe-fitting portion 110 is provided with a detachable label holder 130, in the illustrated example in the form of a collar with a gap 132 in the circumference of the collar. The collar is provided with a plurality of clips 134 disposed circumferentially around the base of the collar, and these grip a flange at the top of the syringe-fitting portion 110. The diameter of the collar may be selected such that the clips 134 are biased inwards to grip the flange 136, for example by making a diameter of the collar slightly smaller than defined by the syringe-fitting portion 110. The diameter of the collar is chosen to be slightly smaller than that of the syringe so that when the syringe 160 is inserted into the syringe-fitting portion 110 the collar 130 expands and clips 134 release the flange 136, so that when the syringe is withdrawn from the device the label holder 130 remains attached to the syringe and is detached from device 100.

FIGS. 1b and 1c illustrate a moulded embodiment of a device similar to that of FIG. 1a, in use. In these and subsequent figures like elements to those previously described are indicated by like reference numerals.

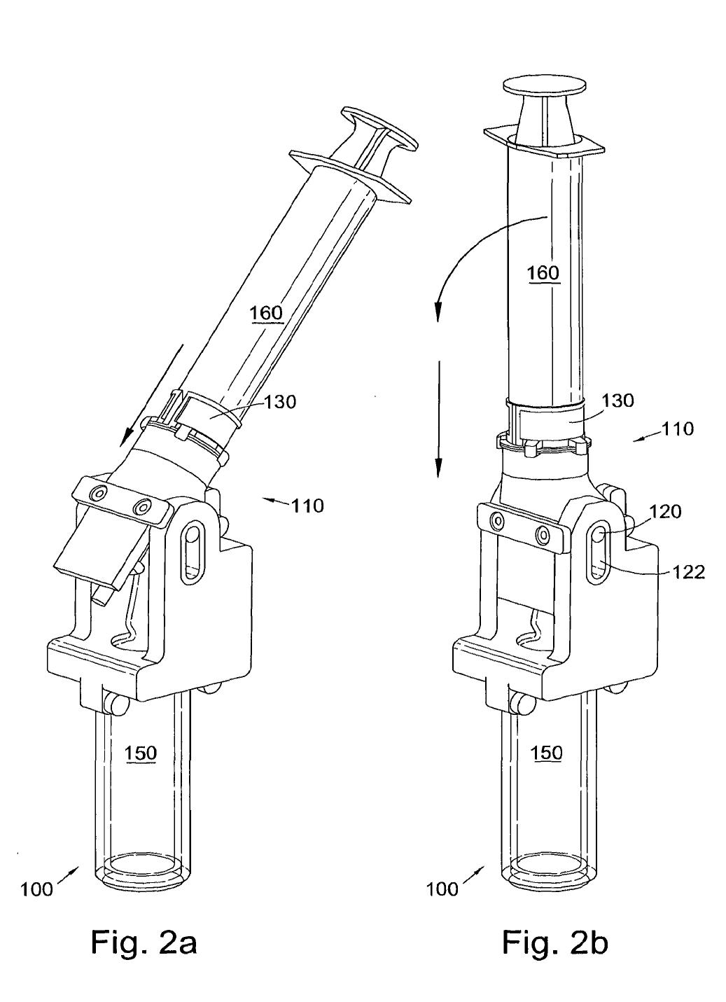

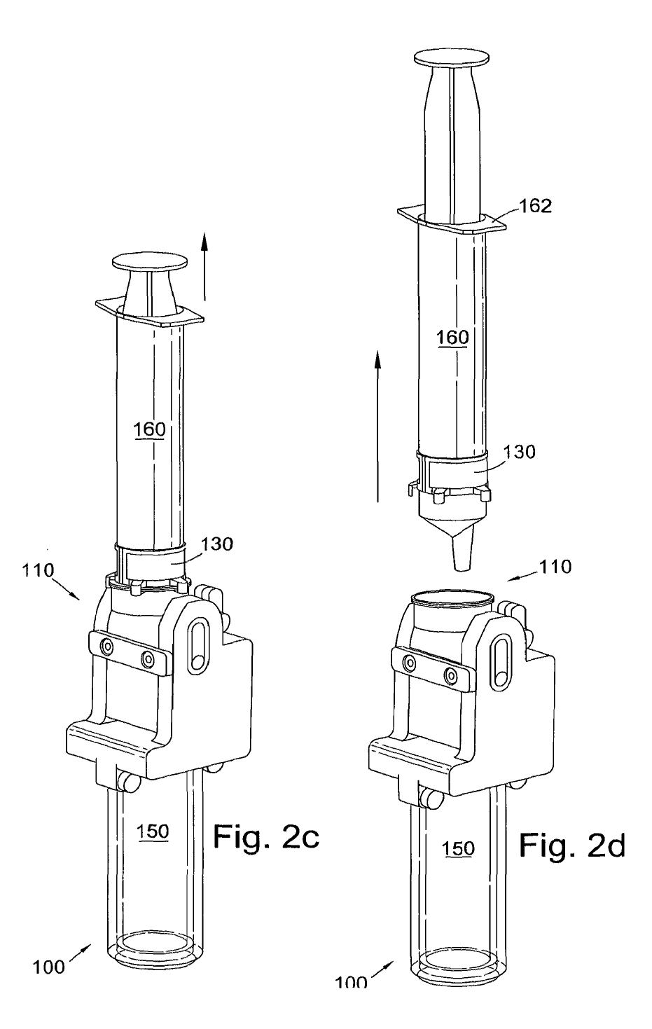

Referring now to FIGS. 2a to 2d, these illustrate stages in the use of the device 100. Thus FIG. 2a illustrates insertion of the syringe 160 into the syringe-fitting portion 110; FIG. 2b illustrates rotation of the syringe and syringe-fitting portion to align the syringe 160 with the ampoule 150 (and the syringe-fitting portion with the ampoule-mounting portion), thereby snapping off the snap top 152 of the ampoule (although not apparent, in FIG. 2b the ampoule top is snapped off). Then the syringe and syringe-fitting portion are pushed towards the ampoule-mounting portion so that the pivot 120 slides along slot 122, to insert the aspiration tip or nozzle 116 of the syringe-fitting portion into the ampoule, before drawing up the contents of the ampoule into the syringe (FIG. 2c). Then, in FIG. 2d, the syringe 160 is removed from the device with the label holder 130 attached to the syringe. Initially the label holder is at the base of the syringe; in embodiments the label holder is provided with a set of internal teeth or barbs so that the label holder moves easily only in one direction along the syringe body, so that it cannot easily be removed after filling the syringe. Optionally the label holder 130 may be pushed up towards the flange 162 of the syringe so that it does not obscure gradations on the syringe and/or the label holder may be formed of clear plastic.

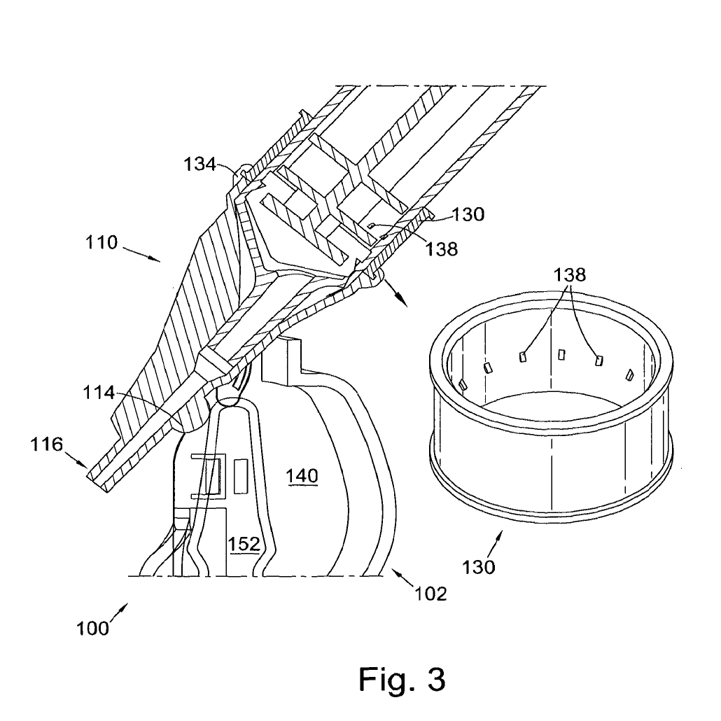

FIG. 3 illustrates the label holder 130 and its attachment to the device 100 in an example embodiment, in more detail. Thus FIG. 3 shows a set of metal barbs 138 which engage the outer plastic body of the syringe 160. When the syringe is inserted, the metal barbs lock the label ring to the syringe.

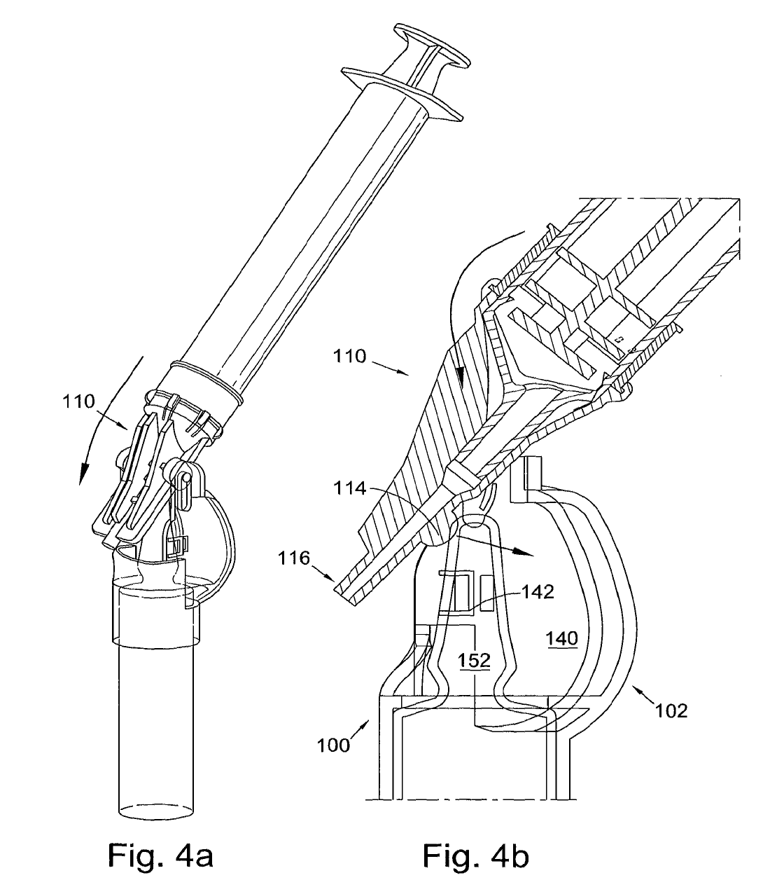

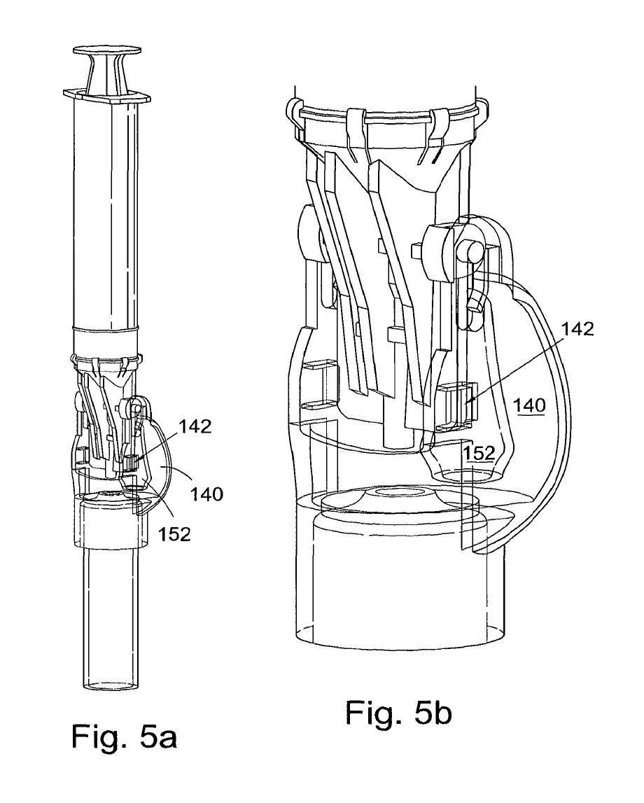

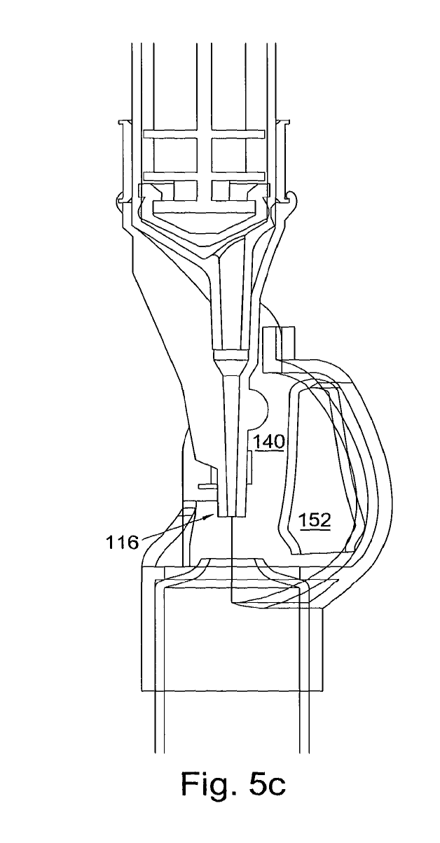

FIG. 4 illustrates the process of snapping the top off the ampoule in more detail. As can be seen the projection 114 of the syringe fitting portion bears against the top 152 of the ampoule and when the top is broken off it is received by a cavity 140 within the ampoule-mounting portion. As can be seen the length of the syringe provides a lever which helps a user to snap the top off the ampoule. In some preferred embodiments a snap lock 142 is provided to lock the syringe in its vertical position once the top of the ampoule has been snapped off. This is illustrated in more detail in FIGS. 5a and 5b, which show the ampoule top 152 locked into cavity 140 by mating male and female snap features 142 on the syringe-fitting portion and ampoule-mounting portion (main body) of the device. FIG. 5c shows in more detail how the ampoule top is securely retained in cavity 140 by the nozzle and female luer of the syringe-fitting portion of the device.

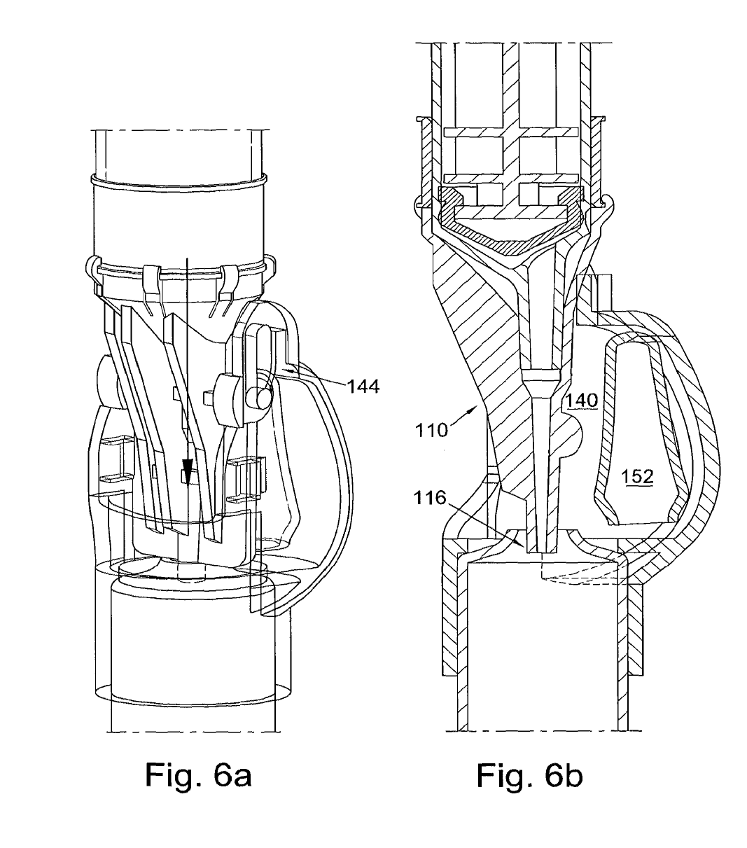

FIGS. 6a and 6b illustrate insertion of the syringe, more particularly the female luer fitting (luer receiving portion) of the syringe-mounting portion 110 into the ampoule so that the aspirating nozzle/tip 116 is 1-2 mm below the open end of the nozzle. In some preferred embodiments when the syringe slides down into the top of the ampoule, positioning it for aspiration, a second lock 144 locks the syringe fitting portion into its aspirating position. Again, in embodiments, the lock 144 may comprise a mating pair of snap features on the syringe-fitting portion 110 and ampoule-mounting portion 102 respectively, for example a plastic ratchet.

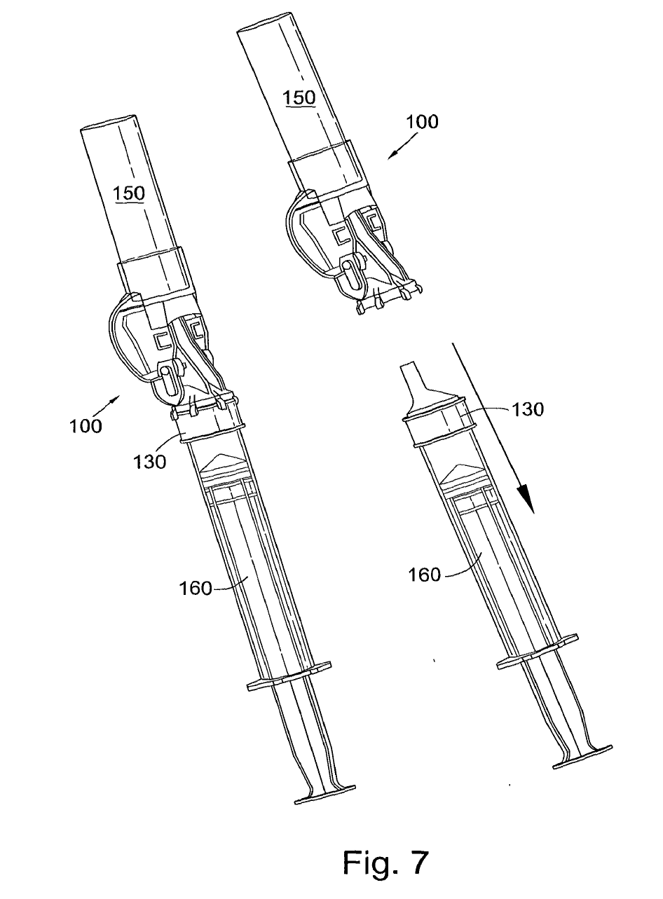

FIG. 7 illustrates filling of the syringe with the contents of the ampoule, normally done in an inverted position as illustrated (surface tension inhibits the liquid contents of the ampoule from spilling out during this process). Then the syringe 160 is removed from the device, bearing the label holder 130. At this stage the device 100 encloses the emptied ampoule and sharp elements and, depending upon local regulations, may then be disposed of in normal rather than special “sharps” waste.

Thus the device aids a clinician in the transfer of liquid medication from a glass ampoule to a syringe. The safety features mean that it is difficult to incorrectly label a syringe without deliberate intent to do so.

It is envisaged that the device will be shipped with a filled ampoule already in place. This places the responsibility for getting the correct drug/label combination on the drug company. The fitting of the device can be seen as the final stage in the packaging process. (The syringe is unlikely to be shipped together with the device).

In embodiments the device is made entirely from injection moulded plastic, with the possible addition of some thin metal components to help the label ring grip onto the outer surface of the syringe. The device described above is a machined prototype: the general functionality of a production device may be similar to this, but made from fewer components and specifically designed to prevent multiple use.

Suitable materials for manufacture include polypropylene (PP), high-density polyethylene (HDPE) and polycarbonate (PC). The benefit of PC is its optical clarity which aids vision of the ampoule itself (to see if air bubbles remain, for example) and gradations on the syringe that is to be used. It is also possible to tint PC such that a colour is imparted to correspond to the drug whilst maintaining a good degree of optical clarity.

The mechanism in the machined prototype may be modified for moulding. In the machined embodiment, the Cam Follower slides over the Cam Surface, providing the desired rotation-followed-by-sliding motion. However it may be preferable to use pivots and links rather than a sliding mechanism, and ‘living hinges’ may be used to simplify assembly and reduce the number of parts. (Broadly, a living hinge is a hinge made from a locally thinned piece of plastic between two thicker, more solid sections of the same component).

Use of the device is as follows, in an example procedure:
unpack the device. This may comprise removing it from a standard Tyvek™ pouch as is used to pack a syringe, or a rip-off strip may be provided that is directly attached to the device.
unpack a suitable syringe. Note that different versions of the device may each be dedicated to a single syringe size to ensure that no half-doses are given.
orient the syringe such that the male luer fitting on the end lines up with the female luer fitting in the syringe housing (syringe fitting portion of the device).
press the syringe into the device. The luer fitting should be made and the devices should be well locked together. At this point, the label ring will have gripped onto the syringe.
lift the syringe upwards to straighten the device. This will break the Ampoule

Cap off the Ampoule and an audible ‘crack’ can be heard. This is followed by a ‘click’ as the Syringe Housing locks into this position to prevent re-use.
press the syringe down towards the ampoule. In the final device, another click will be heard as the mechanism locks into a final position, thus preventing any re-use or the glass ampoule cap from falling out. The aspiration tip will now be inside the neck of the ampoule and in embodiments the cover plate substantially completely covers the sharp parts of the ampoule and the broken-off cap.
invert the device and aspirate the medication in the usual way.
when the drug has been transferred to the syringe, the syringe can be removed: The label holder (label ring) comes away with the syringe, ensuring that the label and drug correspond to one another.

In embodiments the device allows drugs to be supplied in glass ampoules, hence extending shelf life. In some preferred examples of the device the drug is drawn through the aspiration tip 116 and through a filter (not shown in the drawings). In embodiments the drug may be drawn up into the syringe through a 0.2 μm filter, to provide sterility and for the absence of microscopic glass shards. Afterwards, a part of the device may be applied to the tip of the syringe as a sterile bung. During the process, a label is applied to the syringe stating drug name, class and dose. This removes the labelling step, which is prone to error. Preferably the label is large enough to allow large print and use of colour and visual cues to reduce errors caused by selecting the wrong drug.

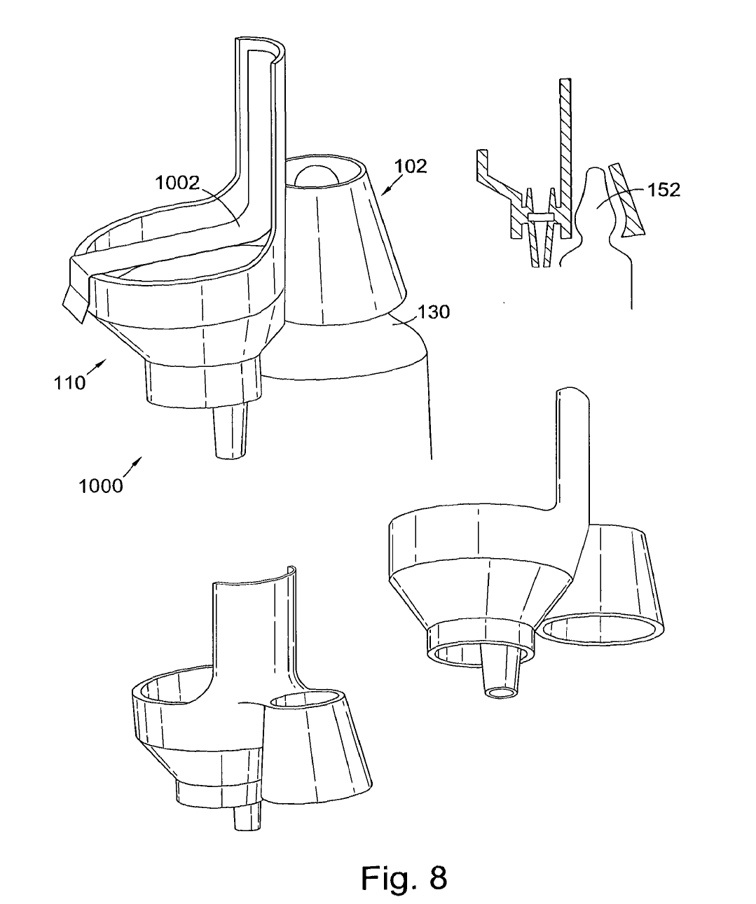

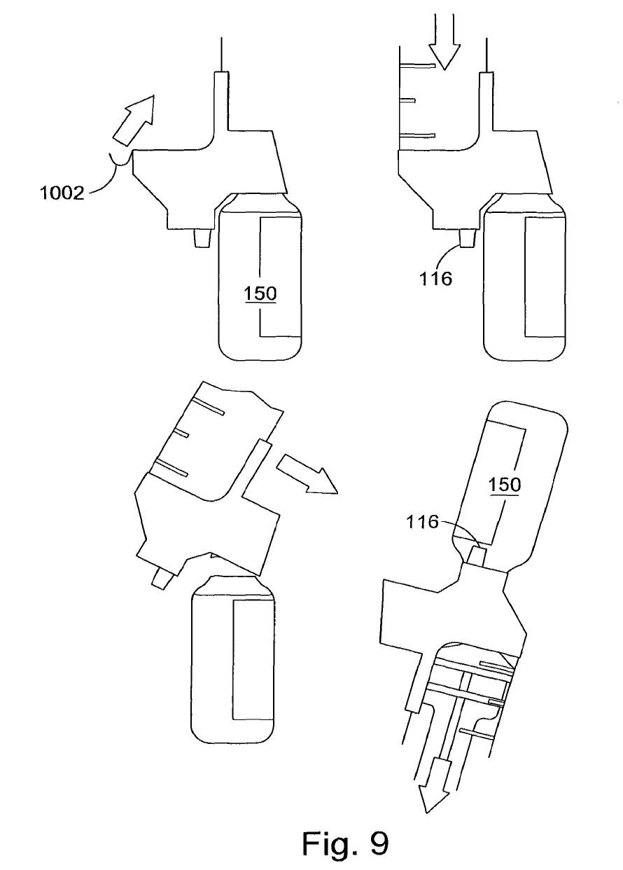

Referring now to FIG. 8, this shows a further example of a syringe labelling device 1000 comprising a once-piece moulded plastic item in which the ampoule-mounting portion 102 provides a cap for the snap-top of the ampoule, and in which a label 1002 is attached over the female luer of the syringe-fitting portion 110 so that this must be removed before the syringe can be filled. FIG. 9 illustrates steps in the use of the device: removing the label, fitting a syringe, using a syringe as a lever to break the top off the ampoule, and then inserting the nozzle 116 of the syringe-fitting portion into the ampoule and filling the syringe (in an inverted position).

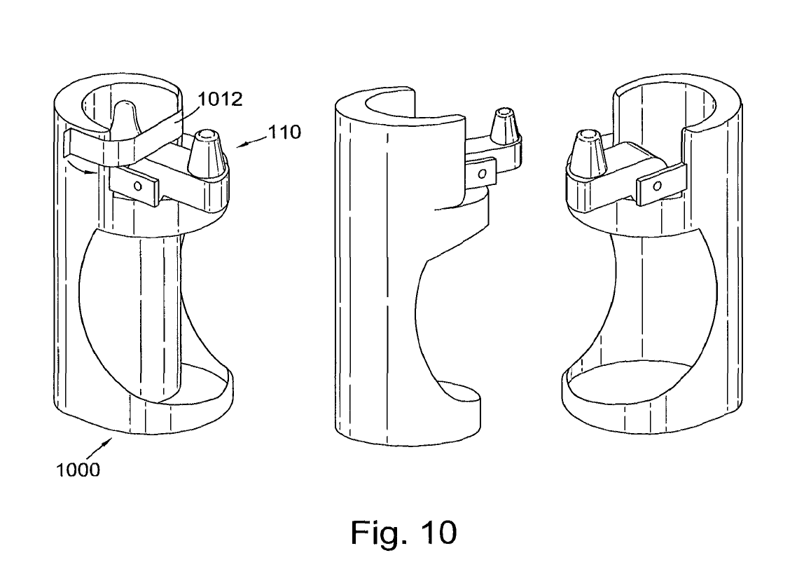

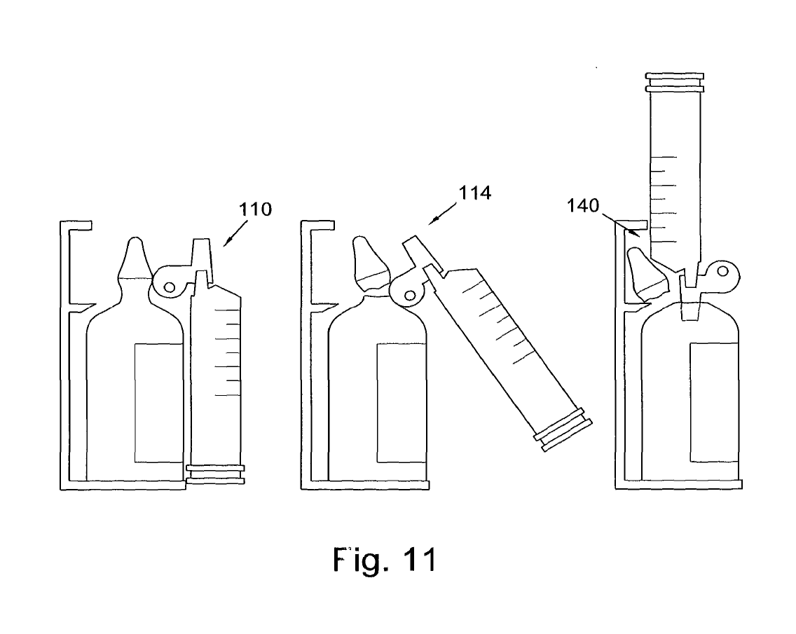

FIG. 10 illustrates a second example of a device 1010 for snapping the top off an ampoule and labelling a syringe. In this example a label 1012 is placed across the snap-top of the ampoule when the ampoule is mounted in the device, so that this label must be removed before the top can be snapped off the ampoule. The syringe-fitting portion 110 is hinged to the device, for use as illustrated in FIG. 11: the tip of the syringe is inserted into the syringe-fitting portion when the syringe and ampoule are parallel to one another and then the syringe is used as a lever so that the forcing portion 114 of the device snaps off the snap-top of the ampoule, to contain this within cavity 140, allowing the syringe and ampoule to be aligned (anti parallel) for the syringe to be filled.

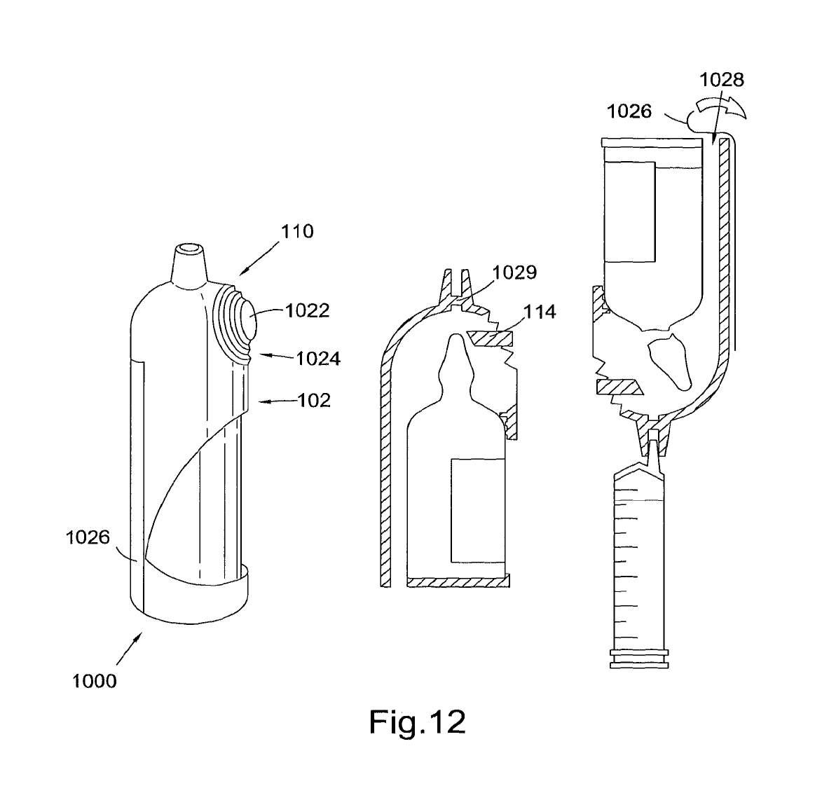

FIG. 12 illustrates a further example of a device 1020 for breaking the top off an ampoule and enforcing labelling of a syringe filled with the contents of the ampoule. In this example a push button 1022 transmits a force to the ampoule top for snapping the top off. The push button 1022 is coupled to the ampoule mounting portion 102 by a set of bellows 1024 and the ampoule-mounting portion comprises a moulded housing which provides a substantially air-tight enclosure for the top of the ampoule. A detachable label 1026 covers an air bleed hole 1028 into the space above the top of the ampoule and thus this label must be removed in order to permit the syringe to be easily filled with the contents of the ampoule. The cross sectional views of FIG. 12 also show a particle filter 1029 between an inlet to the syringe and the ampoule opening, for example a mechanical 0.2 μm filter. In some preferred implementations of the previously described devices such a filter is also present, to filter glass particles from the aspirated drug.

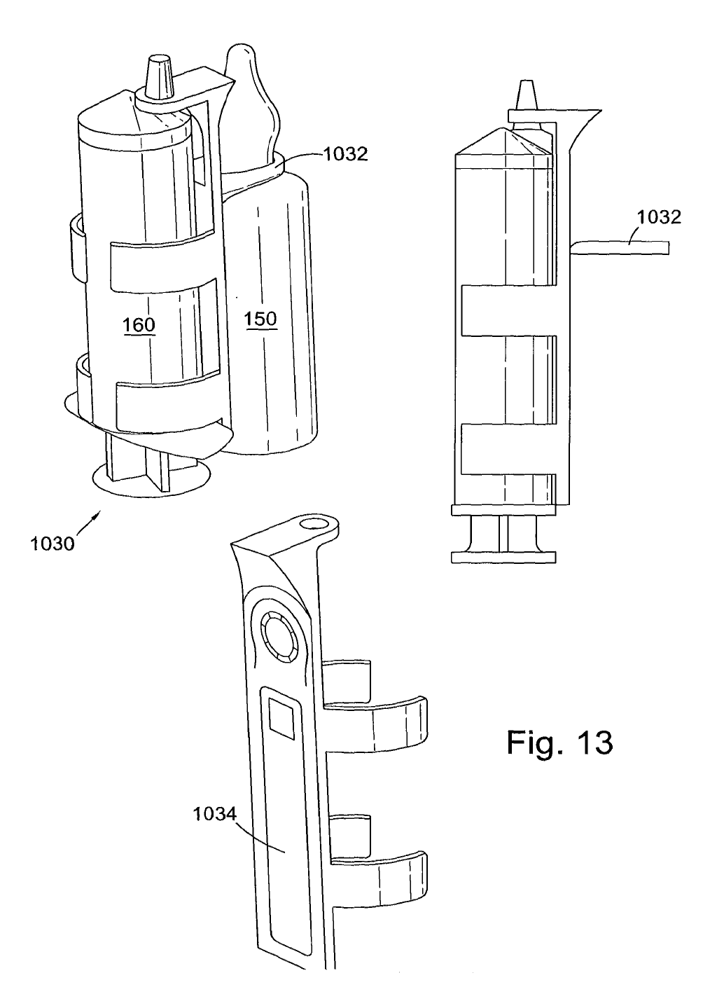

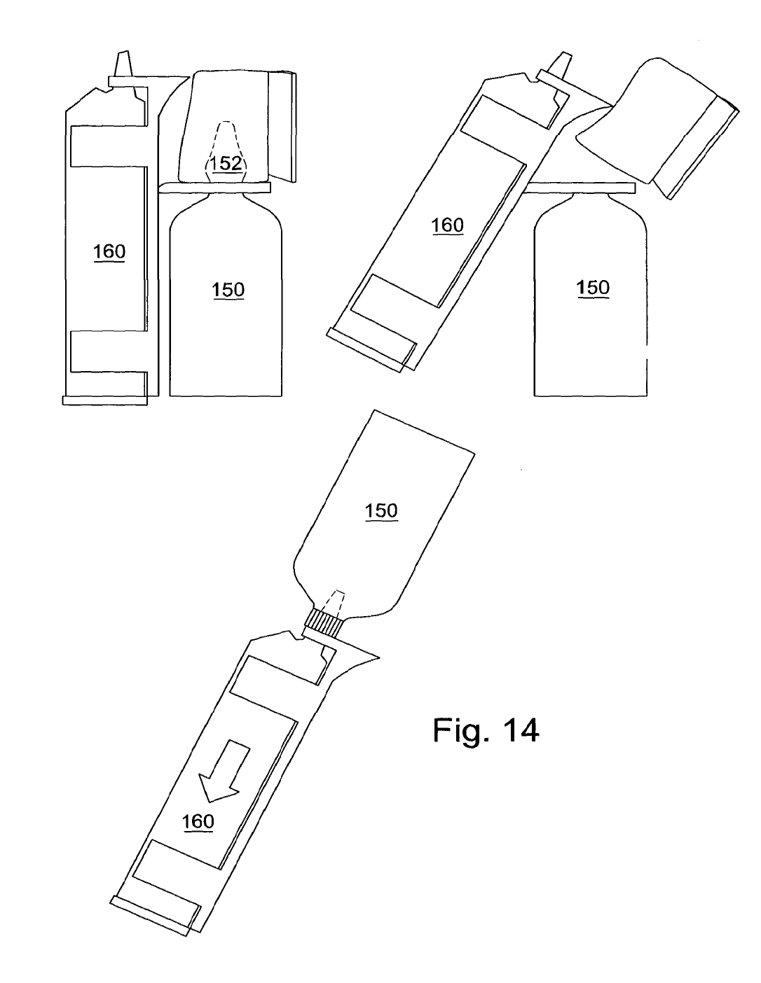

FIG. 13 illustrates a further example of a device 1030 for snapping off the top of an ampoule and labelling a syringe. In the example at FIG. 13 it is anticipated that the syringe, ampoule and device 1030 will be shipped together, as illustrated. The ampoule is held around the neck of the ampoule by a collar 1032 which, preferably, can be folded to lie flat against the device 1030. A label 1034 is attached to the device (permanently) and remains on the device, which remains attached to the syringe after filling with the contents of the ampoule, as illustrated in FIG. 14. The ampoule top may be snapped off manually, this being facilitated by the ampoule being held by the device 1030. Once the ampoule top has been removed the ampoule is detached from the device and the syringe, which remains attached to the labelled device, is filled with the contents of the ampoule.

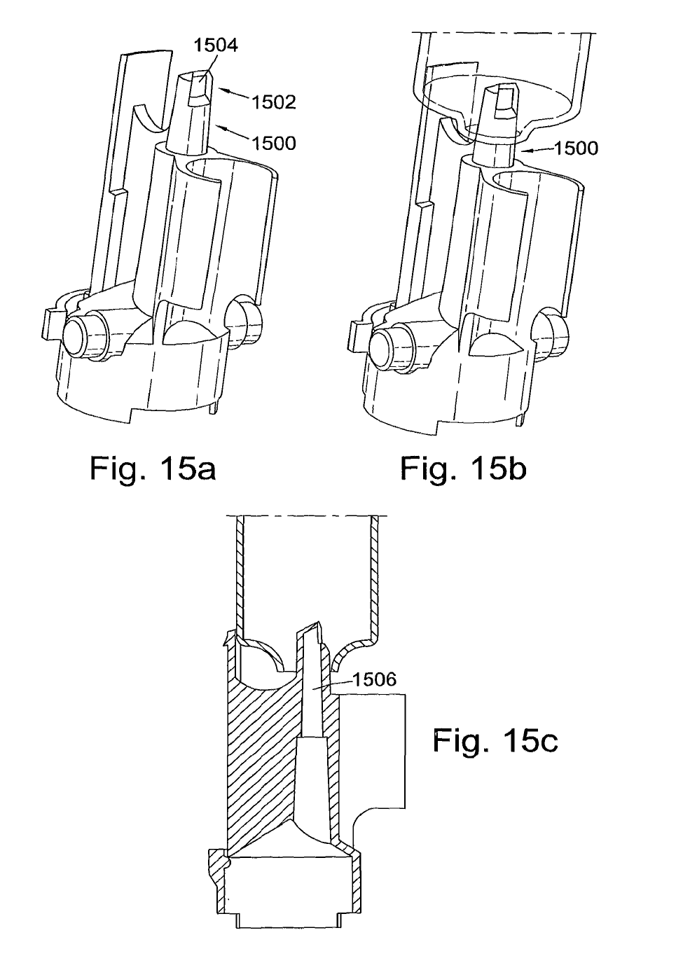

Referring now to FIG. 15, this shows an example of an aspiration tip 1500 of the syringe fitting portion of the device, the tip comprising a nozzle 1502 having an opening 1504 on one side leading into an internal chamber or conduit 1506 to the female luer for mounting the syringe. As can be seen in FIG. 15c, in use the aspiration tip is off-centre within the neck of the ampoule. A filling needle for filling a syringe without using the labelling device may simply comprise a short metal shaft, for example 10-30 mm long, with a blunt, closed end and an opening towards a tip on one side to provide fluid communication with a longitudinal internal conduit, leading to a female luer at the other end of the needle. Thus, broadly speaking, such a needle may comprise a “stripped down” version of the syringe fitting portion illustrated in FIG. 15c.

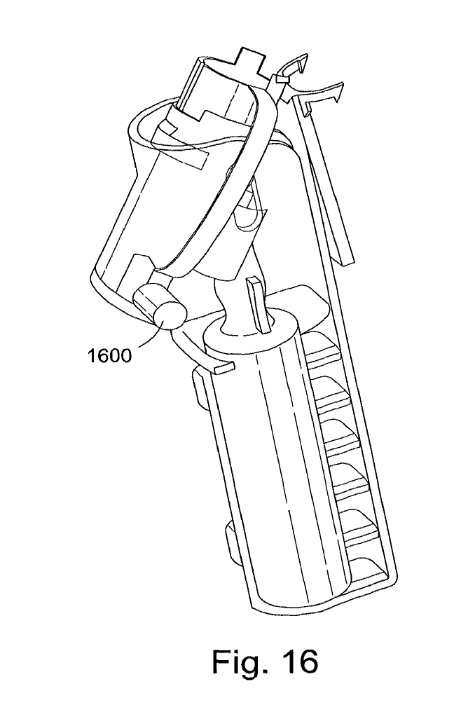

FIG. 16 illustrates an example of a cap 1600 which may be moulded with the label part of the device. Once filled the syringe is withdrawn from the device and the cap allows for short-term storage of the syringe without contaminating the tip.

No doubt many other effective alternatives will occur to the skilled person. It will be understood that the invention is not limited to the described embodiments and encompasses modifications apparent to those skilled in the art lying within the spirit and scope of the claims appended hereto.

1-46. (canceled)

47. A device for attaching to an ampoule to facilitate filling a syringe from the ampoule, the device comprising:
an ampoule-mounting portion for mounting the device to a filled ampoule; and
a syringe-fitting portion to enable the device to be fitted onto said syringe;
wherein the device has two configurations, a first, syringe-attaching configuration for attaching said syringe to the device and a second, syringe-filling configuration for filling said syringe with liquid from said filled ampoule;
wherein the device is reconfigurable between said first configuration and said second configuration and said configuration; and
wherein said reconfiguration between said first configuration and said second configuration applies a force to snap-off a snap-top of said ampoule.

48. A device as claimed in claim 47 further comprising a cavity to capture and hold a snapped-off top of said ampoule.

49. A device as claimed in claim 47 wherein said syringe-fitting portion of said device is hingedly attached to said ampoule-mounting portion of said device;
wherein in one of said configurations said syringe-fitting portion holds said syringe at an angle to said ampoule such that said syringe and said ampoule are out of longitudinal alignment with one another;
wherein in the other of said configurations said syringe-fitting portion holds said syringe in longitudinal alignment with said ampoule to enable said syringe to be filled from said ampoule; and
wherein hinging said syringe-fitting portion of said device with respect to said ampoule-mounting portion of said device brings a forcing portion of said device to bear on a snap-top of said ampoule to snap off said snap-top.

50. A device as claimed in claim 49 wherein said hinged attachment between said syringe-fitting portion of said device and said ampoule-mounting portion of said device is configured to allow both relative rotation and relative translation between said portions of said device such that said syringe-fitting portion is constrained to first predominantly rotate with respect to said ampoule-mounting portion and then to predominantly translate towards said ampoule-mounting portion, to said bring said forcing portion of said device to bear on said snap-top to snap off said snap-top, and then to move a nozzle of said syringe-filling portion towards an open top of said ampoule.

51. A device as claimed in claim 49 wherein said hinged attachment comprises a sliding hinge.

52. A device as claimed in claim 49 wherein said hinged attachment comprises a 4-bar linkage.

53. A device as claimed in claim 49 further comprising a rotation lock to inhibit rotation back once said syringe-fitting portion and said ampoule-mounting portion are longitudinally aligned.

54. A device as claimed in claim 49 further comprising a cavity to capture and hold a snapped-off top of said ampoule, wherein said forcing portion of said device which bears on said snap-top is arranged to push said snapped off top into said cavity.

55. A device as claimed in claim 47 further comprising a safety lock to inhibit motion of said syringe-fitting portion away from said ampoule-mounting portion once said snap-top has been snapped off.

56. A device as claimed in claim 47 further comprising a detachable label holder to hold a label for the contents of said ampoule, and wherein said label holder is configured to engage said syringe on or after fitting of said syringe into said device, such that on withdrawal of said syringe from said device after filling said detachable label-holder is detached from said device and attached to said syringe.

57. A device for attaching to an ampoule to facilitate filling a syringe from the ampoule, the device comprising:
an ampoule-mounting portion for mounting the device to a filled ampoule;
a syringe-fitting portion to enable the device to be fitted onto said syringe; and
a cavity for holding a snapped-off top of said ampoule;
wherein said syringe fitting portion is hingedly attached to said ampoule mounting portion;
wherein the device has two configurations, a first, syringe-attaching configuration in which an axis of the syringe fitting portion is at an oblique angle to an axis of said ampoule-mounting portion and a second syringe-filling configuration in which the syringe fitting portion and the ampoule-mounting portion are aligned to enable the syringe to be filled from the ampoule;
wherein the device is reconfigurable between said first configuration and said second configuration and said configuration; and
wherein, in going from said first to second configuration, the ampoule top is snapped off and the top is captured in the cavity.

58. A device as claimed in claim 57 wherein said cavity is located substantially behind a hinging junction between said syringe-fitting portion and said ampoule-mounting portion.

59. A device as claimed in claim 57 wherein said ampoule-fitting portion is configured to hold said ampoule at both a neck and a base end of said ampoule.

60. A device as claimed in claim 57 further configured to automatically label said syringe, the device further comprising:
a label holder to hold a label for contents of said ampoule;
wherein one of said syringe and said ampoule is detachable from said device; and
wherein said label holder is configured such that in conjunction with a filling operation of said syringe and detachment of said one of said syringe and said ampoule from said device said syringe is able to be labelled by said label.

61. A device as claimed in claim 60 wherein said label is detachable from said device for attachment to said syringe in conjunction with said filling operation, and wherein said detachable label is positioned such that said label must be at least partially removed for an effective said filling operation.

62. A device as claimed in claim 60 having a portion configured for snapping off a snap-top of said ampoule, wherein said portion configured for snapping off said snap-top comprises a cap or collar for said snap-top.

63. A device as claimed in claim 62 wherein said syringe-fitting portion of said device is mounted to allow motion of said syringe-fitting portion relative to said device such that said motion applies a force to said snap-top to perform said snapping off.

64. A device as claimed in claim 62 configured such that said label holder is released to enable attachment of said label to said syringe by said snapping off of said snap-top.

65. A device as claimed in claim 60 for automatically labelling said syringe, wherein said label holder is detachable from said device and configured such that, when said syringe is engaged with said syringe-fitting portion and then removed from said syringe-fitting portion, said label holder attaches to said syringe and is detached from said device to automatically label said syringe.

66. A device as claimed in claim 65 wherein said label holder comprises a collar for said syringe.

67. A device as claimed in claim 66 wherein said label holder further comprises a fold-out longitudinal label portion attached to said collar, for folding out to lie parallel to an axis of said collar and along a longitudinal length of said syringe.

68. A device as claimed in claim 57 wherein said syringe-fitting portion of said device is hingedly attached to said ampoule-mounting portion of said device;
wherein in said first configuration said syringe-fitting portion holds said syringe at an angle to said ampoule such that said syringe and said ampoule are out of longitudinal alignment with one another;
wherein in said second configuration said syringe-fitting portion holds said syringe in longitudinal alignment with said ampoule to enable said syringe to be filled from said ampoule; and
wherein hinging said syringe-fitting portion of said device with respect to said ampoule-mounting portion of said device to bring said syringe into longitudinal alignment with said ampoule brings a forcing portion of said device to bear on a snap-top of said ampoule to snap off said snap-top.

69. A device as claimed in claim 68 wherein said hinged attachment between said syringe-fitting portion of said device and said ampoule-mounting portion of said device is configured to allow both relative rotation and relative translation between said portions of said device such that said syringe-fitting portion is constrained to first predominantly rotate with respect to said ampoule-mounting portion and then to predominantly translate towards said ampoule-mounting portion, to said bring said forcing portion of said device to bear on said snap-top to snap off said snap-top, and then to move a nozzle of said syringe-filling portion towards an open top of said ampoule.

70. A device as claimed in claim 57 further comprising a safety lock to inhibit motion of said syringe-fitting portion once said snap-top has been snapped off.

71. A one-piece moulded device for attaching to an ampoule to facilitate filling a syringe from the ampoule, the device comprising:
an ampoule-mounting portion for mounting the device to a filled ampoule; and
a syringe-fitting portion to enable the device to be fitted onto said syringe; and
wherein said ampoule-mounting portion comprises a cap for a snap-top of the ampoule;
wherein said syringe-fitting portion comprises a female luer fitting for the syringe;
wherein an opening of said cap to receive said ampoule faces in a generally opposite direction to an opening of said female luer fitting to receive said syringe such that, in use, said syringe and said ampoule are generally antiparallel; and
wherein, in use, said syringe is usable as a lever to snap off said snap-top of said ampoule.

72. A device as claimed in claim 71 wherein said syringe-fitting portion has an aspiration tip, and wherein said aspiration tip comprises a nozzle with an opening on one side.

73. A device as claimed in claim 72 wherein said nozzle is closed at the end.

74. A device as claimed in claim 72 configured to hold said aspiration tip off-centre in a neck opening of said ampoule when aspirating the contents of said ampoule.

75. A device as claimed in claim 74 wherein the device is configured to hold said aspiration tip such that a space between said nozzle and a first portion of said neck is smaller than a space between said nozzle and a second portion of said neck, and wherein said opening of said nozzle is arranged to face said first portion of said neck.

76. A device as claimed in claim 71 wherein said syringe-fitting portion incorporates a mechanical particle filter in a fluid passage between a nozzle of said syringe-fitting portion to receive a fluid from said ampoule and a fluid connection to said syringe.
